(19) United States
(12) Patent Application Publication
(10) Pub. No.: US 2006/0224532 A1
(43) Pub. Date: Oct. 5, 2006

(54) Iterative feature weighting with neural networks

(75) Inventors: Baofu Duan, Cleveland Heights, OH (US); Yoh-Han Pao, Cleveland Heights, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Case Western Reserve University, Cleveland, OH (US)

(21) Appl. No.: 11/260,856

(22) Filed: Oct. 27, 2005

Related U.S. Application Data
(60) Provisional application No. 60/660,071, filed on Mar. 9, 2005.

(51) Int. Cl. G06N 3/02

(52) U.S. Cl. 706/15

(57) ABSTRACT

Systems, methodologies, media, and other embodiments associated with feature weighting in neural networks are described. One exemplary method embodiment includes using a set of weights to scale input feature values. Then the scaled data are used to train a neural net model of the relationship to be learned. The learned model is used to produce a new set of feature weights. The procedure continues iteratively until stopping criteria is met.

### CROSS-REFERENCE TO RELATED APPLICATIONS

This application claims the benefit of U.S. Provisional Application No. 60/660,071 filed Mar. 9, 2005, incorporated by reference herein in its entirety.

### BACKGROUND

In multivariate data analysis, samples may be described in terms of many features, but in specific tasks some features may be redundant or irrelevant, service primarily as sources of noise and confusion. Irrelevant or redundant features not only increase the cost of data collection, but may also be the reason why machine learning is often hampered by lack of an adequate number of samples.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. The drawings are not to scale and the proportion of certain elements may be exaggerated for the purpose of illustration.

FIG. 1 illustrates an example system for feature weighting with a neural network.

FIG. 2 illustrates an example method for feature weighting with a neural network.

FIG. 3 illustrates another example method for feature weighting with a neural network.

FIG. 4 illustrates another example system for feature weighting with a neural network.

FIG. 5 illustrates results obtained on sample data using an exemplary method for feature weighting with a neural network.

FIG. 6 illustrates results obtained on sample data using an exemplary method for feature weighting with a neural network.

FIG. 7 illustrates results obtained on sample data using an exemplary method for feature weighting with a neural network.

FIG. 8 illustrates an expression profile for a selected gene in the sample data.

FIG. 9 illustrates an expression profile for a selected gene in the sample data.

### DETAILED DESCRIPTION

For the purposes of the present discussion, given objectives and circumstances, a competent machine would generate appropriate acceptable or near optimal responses to external stimuli especially if similar circumstances had been experienced by the machine previously. If the machine can cope with similar but somewhat different circumstances through generalization (interpolation mostly) or through extrapolation (trial and error, search, testing), the machine might be considered to be adaptive as well as competent, to varying extents. If the machine through various means can form new ways for generating competent adaptive responses it might be considered to be creative, to varying degrees. If several of these characteristics are available and are used in combination to provide novel improved modes of responses, the machine might be considered to be intelligent in certain aspects of its total overall behavior.

It is now quite widely accepted that certain aspects of adaptive competent behavior can be achieved through the use of artificial neural networks. Given a memory of sets of specific input feature values and associated response outputs, the adaptive competent machine can generate useful extensions of previously encountered associations. The examples are not extended but response generating procedures are assumed to be valid for circumstances beyond the boundaries of previously experienced circumstances.

These system capabilities may be used to great effect in standard tasks such as classification, regression or prediction. However high quality adaptive competent machine behaviors can be attained only with great care, with great attention to detail.

Two related issues are especially to be given great attention, one being that in generalization the machine should avoid introducing spurious input features in the learning of rules and associations, and secondly that the machine should not be “overtrained”, otherwise in generalization the computational models will give high resolution description of noise. In other words, all components involved should not generate irrelevant features and one should be able to discriminate against irrelevant and/or noisy features.

In one embodiment, these characteristics of adaptive competent behaviors may be attained using artificial neural networks.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

The term “neural network” as used herein is used in a generic sense and includes, but is not limited to, various network architectures such as Multilayer Perceptron (MLP), Radial Basis Function (RBF), Support Vector Machines (SVM) and the like.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Pern, SQL, APIs, SDKs, assembly, firmware, microcode, and/or other languages and tools now known or later developed. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

In multivariate data analysis, irrelevant or redundant features not only increase the cost of data collection and processing, but may also be the reason why machine learning is often hampered by lack of an adequate number of samples. Feature selection may be used to identify and select only those features that are relevant to the specific task in question. An alternate approach may be feature weighting that assigns continuous-valued weights to each and all the features used in the description of data samples. Feature weighting can help reduce the effect of irrelevant or less than optimal features by assigning 0 or smaller weights to them and larger weights to more relevant features or those features that appear more relevant.

In one embodiment, we describe a framework for iterative feature weighting with neural networks. The framework iteratively improves the trained neural networks until reaching an optimal network model. Additionally, or in the alternative, feature weights may be evaluated through trained neural networks to determine convergence to an optimal solution or solutions.

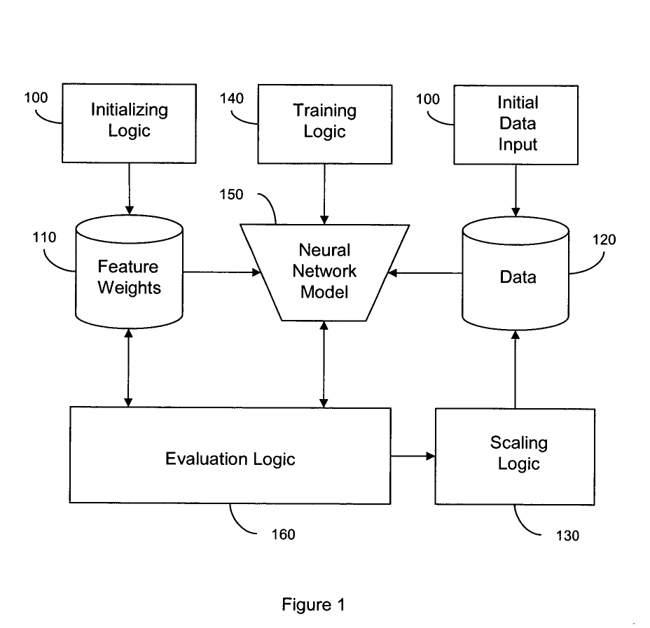

FIG. 1 illustrates an example computer-executable system for weighting features in a neural network. The computer-executable system includes initializing logic 100 configured to establish or assign an initial feature weight for each feature in a neural network model. The feature weights may be stored in a data store such as database 110. Network data, stored for example in a data store such as database 120, may then be scaled by scaling logic 130 with the feature weights from database 110. The scaled data may then be used by training logic 140, for example a neural network training algorithm including greedy algorithms, backpropragation algorithms and the like, to train a neural network model 150. Evaluation logic 160 may then evaluate the feature weights based on the neural network model 150. Based on the evaluation, the feature weights may be updated and/or stored in database 110 and the data may be again scaled by scaling logic 130 using the updated feature weights to continue recursivelIla stopping criterion is met.

Scaling logic 130 may include many various methods to alter the feature weights. For example, the feature weights can be used to change the data representation by scaling feature values using feature weights. One method of data scaling employs a feature weight to multiply the corresponding feature values as shown in equation (1).
Xᵢ′=σᵢxᵢ (1)

Another way of scaling data is to use the square root of a feature weight to multiply the corresponding feature values as shown in equation (2). In RBF networks and SVMs with Gaussian kernels, using equation (2) instead of equation (1) to scale data makes the neural networks functions of the feature weights rather than functions of the squares of the feature weights. This procedure somewhat simplifies the feature evaluation functions with desirable effects to the evaluation of the feature weights.

$${x}_{i}^{′} = \sqrt{{σ}_{i}} {x}_{i} \qquad ( 2 )$$

Data scaling may play a role in feature weighting methods with neural networks. For RBF networks and SVMs with Gaussian kernels, the activation of a Gaussian kernel is determined by the Euclidean distance between the sample and the center of the kernel. Data scaling using feature weights differentiates the contributions of features to the distance computation and consequently the neural networks. For MLP networks, data scaling may appear redundant since the input layer of a MLP network is already a linear transformation of the data. However, since the connection weights in the MLP network are typically randomly initialized, data scaling affects the initial network weights and consequently the trained networks.

Evaluation logic 160 may update feature weights from a trained neural network. Different feature evaluation functions have been developed and can be classified into two categories based on the partial derivatives they use. One type of feature evaluation function uses the partial derivative with respect to the input features to estimate the values of feature weights. Another type of feature evaluation function uses the partial derivative with respect to the feature weights to estimate the changes of the feature weights.

A neural network may provide a nonlinear mapping from the input feature space to the output space. With data scaling, a neural network may be a nonlinear function of the input features and the feature weights as shown in equation (3) (assumed here as one output case).
y=f(x,σ)=f(x₁, x₂, . . . ,x_{N}, σ₁, σ₂, . . . , σ_{N} (3)

Some feature evaluation functions have been developed that use the derivative with respect to the input features. One example of these feature evaluation functions is to sum the absolute values of the partial derivative ∂f/∂xᵢ over training samples as described in D. W. Ruck et al., “Feature Selection Using a Multilayer Perceptron”, Journal of Neural Network Computing, vol. 2, 1990, pp. 40-48, which is incorporated herein by reference. For P training samples, x⁽¹⁾, x⁽²⁾, . . . , x^{(P)}, the weight for the ith feature can be estimated by

$${σ}_{i} = \frac{1}{P} {\sum }_{p = 1}^{P} \vert \partial f ( {x}^{( p )} ) / \partial {x}_{i} \vert \qquad ( 4 )$$

When using some feature evaluation functions such as equation (4), feature weights of irrelevant features become very small values, but they rarely go to 0 in practice. Therefore, in one embodiment a feature elimination threshold may be established to force small feature weights to zero so that feature weighting can function to remove irrelevant features similar to feature selection. However, if the threshold is too large, relevant features might be removed. If the threshold is too small, there might be still many irrelevant features left. In an embodiment, instead of setting a fixed feature weight threshold, σₜₕᵣₑₛₕ, for all iterations, it may be preferable to set a relative feature elimination threshold, a parameter τ, to estimate the values of σₜₕᵣₑₛₕ over iterations. This is shown in equation (5)

$${max}_{{σ}_{thresh}} ( {\sum }_{{σ}_{i} < {σ}_{thresh}} {σ}_{i} \leq τ \sum {σ}_{i} ) \qquad ( 5 )$$

The relative feature elimination threshold τ is a small positive value definable by users. An advantage of using the relative feature elimination threshold is when there are many features with small weights. For example, instead of removing all of these features, some or all may be kept because the sum of their weights is large.

In the feature weighting methods with SVMs, we see the examples of feature evaluation functions that use the partial derivative with respect to the feature weights. In one method, feature weights may be updated through gradient descent search to minimize bounds on the leave-one-out error. Differently, optimizing bounds over many hyper-parameters may introduce bias and result in overfitting. Instead, another method may use the conjugate gradient search to minimize the standard SVM empirical risk subject to some constraints. Both of the above feature evaluation functions are specific to SVMs and not applicable to MLP and RBF networks. By contrast, using the gradient search to minimize the mean squared error (MSE) of the neural networks may produce more desirable results for MLP and RBF networks. For example, where the target value for a sample x^{(P)} is t^{(P)}, the MSE is computed as

$$MSE = \frac{1}{2 P} {\sum }_{p = 1}^{P} {( {t}^{( p )} - f ( {x}^{( p )} ) )}^{2} \qquad ( 6 )$$

The change of a feature weight is proportional to the partial derivative of MSE with respect to the ith feature weight:
∂σᵢ=−η∂MSE/∂σᵢ (7)
where η is the updating rate.

Returning to data scaling, for RBF networks with Gaussian kernels, if equation (1) is used to scale data, the resultant networks will be functions of the squares of the feature weights. Once a feature weight σᵢ becomes zero, ∂WSE/∂σᵢ becomes zero, i.e., σᵢ can never go back to a positive value. This may be undesirable because the feature weights of relevant features may accidentally turn to zero depending on the updating rate η. But if equation (2) is used to scale data, a feature weight of zero may have a chance to turn to positive during the next iteration.

As described, the types of feature evaluation functions are different from what kind of partial derivatives they use, but may work reasonably well. If the partial derivatives with respect to the input features are used, one should specify the feature elimination threshold in order to remove irrelevant features. If the partial derivatives with respect to the feature weights are used, one should specify the updating rate η. The feature elimination threshold may not be necessary for the latter because feature weights can turn into 0 or even negative values. If a feature weight becomes a negative value, we may alternately limit it to 0 because of the constraint that a feature weight should not be a negative value.

Referring now to training logic 140, in one embodiment the neural network training logic 140 and the feature evaluation logic 160 may be configured so that the trained neural network models and the evaluated sets of feature weights are improved over iterations. For example, where the neural network training logic 140 is configured so that the trained neural network models are typically improved over previous iterations. With neural networks being improved over iterations, the sets of feature weights evaluated from them are very likely improved over iterations though not necessarily monotonically.

In one embodiment, it may not be necessary to train neural network models with high qualities at first, which can be difficult and may cause overfitting because of the presence of irrelevant features. Considering this in configuring the neural network training logic 140, it may be desirable to establish an algorithm that can adapt itself over iterations. In the case where the features are equally weighted, the neural network training logic 140 trains a neural network model 150 which does not have to be of high quality but is better than a null model. From this model, feature weights can be evaluated which are no longer equally valued, i.e., weights can be increased for some features and decreased for some other features. Since the model is better than a null model, the new feature weights are very likely better than the initial weights. In another words, it is more likely that the increased feature weights are for relevant features and decreased for others. Feature weights for some suboptimal features may be increased accidentally, but the overall effect of suboptimal features is reduced when the new feature weights are used to scale the data. Then the training logic 140 can adapt itself to train a new neural network model with improved quality.

Various techniques may be used to configure the training logic 140 to improve the models over iterations.

A greedy method may be used, i.e., the training logic 140 can greedily search in the network model space until it finds an improved neural network model. For example, due to the randomness of the initial network weights of MLP networks, sometimes it is difficult to train an improved model with the improved feature weights. In this case, the training logic 140 may employ different random initial network weights with the feature weights being fixed until an improved model is trained.

Another technique employs regularization. Regularization may help the training logic 140 to smooth the trained model so as to improve its generality. The regularization parameters, in this case, are used control the smoothness of the model. The larger the values of regularization parameters, the smoother the trained model can be. When using regularization, the training logic 140 can adapt the regularization parameters over iterations. At first in the presence of many suboptimal features, a large value of the regulation parameter can be used so that the trained neural network model can be smooth. The trained model may initially have low quality but desirably is not overfitted due to the irrelevant features. At the next iteration, the regularization parameters can be reduced since the overall effect of suboptimal features is reduced. This tends to result in a less smooth model but with higher quality. With an increase of the number of iterations, the effect of suboptimal features as well as the regularization parameters decrease until the trained model approaches the optimum.

In another embodiment, the training logic employs cross validation. In training neural network models, it may be desirable to divide the available samples into two datasets, one for training and one for validation. However this may introduce a bias and result in overfitting since it relies on a particular division of samples. Another method employs the k-fold cross validation. The k-fold cross validation divides the data into k subsets. Then each time one subset is used for validation and the remaining k-1 subsets are used for training.

The k-fold cross validation may give a better indication of model quality. But it could result in k trained models. In order to get an unbiased model that can be further used to update feature weights, model averaging can be used. The idea of model averaging is to build different models and average the predictions of these models weighted by their posterior probabilities. In RBF networks and SVMs, the k different models may have many kernels in common, so the model averaging may simply average the weights of the kernels in different models. This can lead to a single unified model and reduce the cost of evaluating feature weights.

Some internal parameters of neural networks can also be adjusted to help the training logic to improve the qualities of models over iterations. For example, in RBF networks and SVMs, the parameters of the kernels can be adjusted by the training logic in correspondence to the change of feature weights.

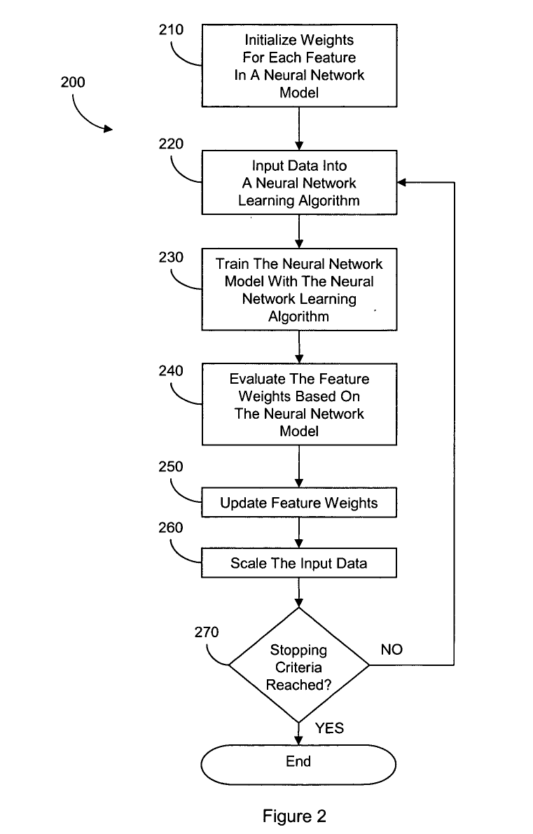

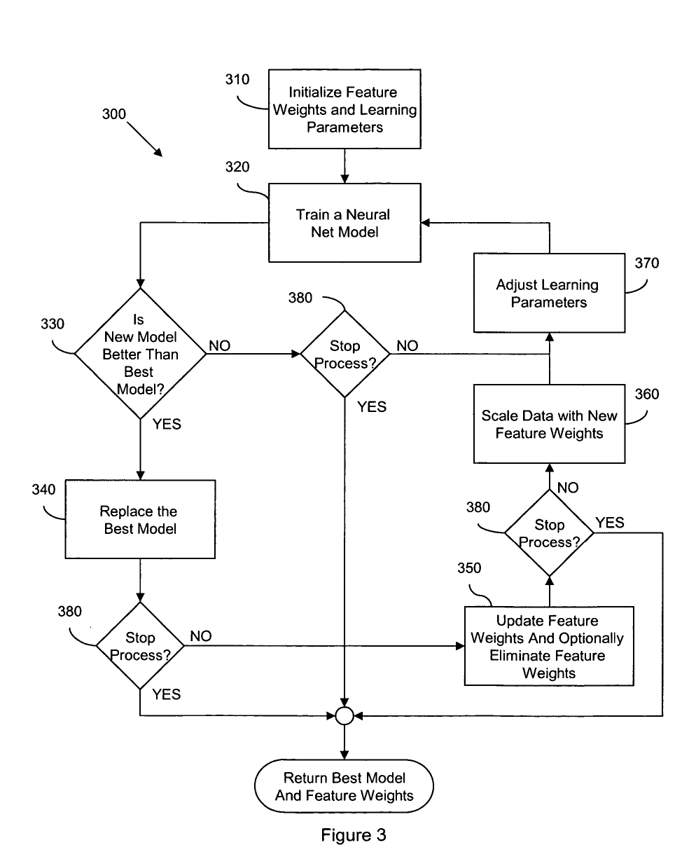

Example methods may be better appreciated with reference to the flow diagrams of FIGS. 2 and 3. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques. The foregoing applies to all methodologies herein.

Illustrated in FIG. 2 is an example methodology 200 for weighting features in a neural network. For example, a computer component may invoke software to initialize feature weights, block 210. Data may be input, with initial feature weights applied, to a learning algorithm, block 220. Using the data as weighted, training logic trains the neural network, block 230. Following previous training, the feature weights are evaluated, block 240, and feature weights may be revised, block 250. The data may then be re-scaled 260 and applied recursively. In the event that further revision is deemed undesirable, perhaps because stopping criteria has been met, block 270, the application may terminate.

Stopping criteria, block 270, may be used to stop the learning process. In many cases, there are several different stopping criteria and they can be combined and used together. One stopping criterion may be that a maximum number of iterations has been reached. The learning process may stop once it reaches the maximum number of iterations. Once this criterion is triggered, typically the learning algorithm is converging very slowly, or is not convergent due to inappropriate configurations.

Another stopping criterion may be that a maximum number of tries has been reached for the neural network learning algorithm so that it can learn an improved model. This criterion may be triggered when the learning process has reached a sub-optimal solution and other criteria have not been triggered. The criterion also allows the neural network learning algorithms to greedily search in the neural network.

Since the quality of a trained neural network is always checked in each iteration, it may be used to stop the learning process at any point if the quality is satisfactory. The relative change of the feature weights can also be used to stop the learning process. If the relative change of feature weights is less than a threshold, the learning process may be configured to stop.

With respect now to FIG. 3, another example methodology for feature weighting with a neural network is illustrated. At block 310, feature weights and learning parameters are initialized. Feature weights may be assigned to “1” so that all features are treated equally at first. Learning parameters are those to be used by the neural net learning algorithm or training logic such as the neural net structure, initial neural net weights, regularization parameters, and the like. Then the neural network model may be trained, block 320. The learned neural net model may then be compared to the best model, block 330. If the learned model is better than the best model, the best model may be replaced by the new model, block 340. Feature weights may then be updated using the new model, block 350. Optionally, feature weights can be used to remove those features with very small values, or that are undesirable, block 350. Then the data may be scaled again using updated feature weights, block 360. The learning parameters may be adjusted after that or when the learned model does not improve over the best one, block 370. Then a new iteration may be begun to train a new neural net mode, block 320. This iterative process may continue until certain stopping criteria is met, blocks 380.

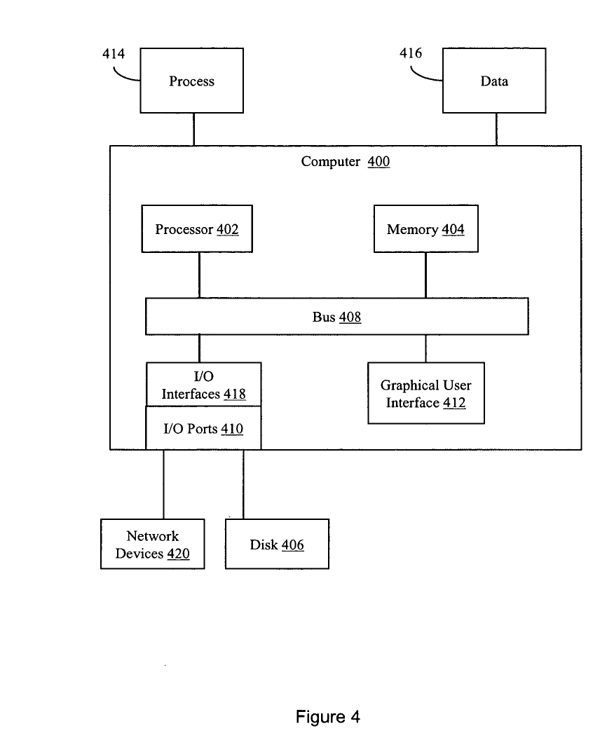

FIG. 4 illustrates an example computing device in which example systems and methods described herein, and equivalents, can operate. The example computing device may be a computer 400 that includes a processor 402, a memory 404, and input/output ports 410 operably connected by a bus 408. The computer 400 can also provide a graphical user interface 412 for user interaction with the computer and/or control of a software operating thereon. Generally describing an example configuration of the computer 400, the processor 402 can be a variety of various processors including dual microprocessor and other multi-processor architectures.

The memory 404 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The memory 404 may store software to implement exemplary methods described herein, processes 414 and/or data 416, for example.

A disk 406, and/or other peripheral devices, may be operably connected to the computer 400 via, for example, an input/output interface (e.g., card, device) 418 and one or more input/output ports 410. The disk 406 can include, but is not limited to, devices like a magnetic disk drive, a solid state disk drive, a floppy disk drive, a tape drive, a Zip drive, a flash memory card, and/or a memory stick. Furthermore, the disk 406 can include optical drives like a CD-ROM, a CD recordable drive (CD-R drive), a CD rewriteable drive (CD-RW drive), and/or a digital video ROM drive (DVD ROM). The disk 406 and/or memory 404 can store an operating system that controls and allocates resources of the computer 400. The disk 406 may be an internal storage device.

The bus 408 can be a single internal bus interconnect architecture and/or other bus or mesh architectures. While a single bus is illustrated, it is to be appreciated that a computer 400 may communicate with various devices, logics, and peripherals using other busses that are not illustrated (e.g., PCIE, SATA, Infiniband, 1394, USB, Ethernet). The bus 408 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 400 may interact with input/output devices via one or more I/O interfaces 418 and input/output ports 410. Input/output devices can include, but are not limited to, a keyboard, a microphone, a pointing and selection device, cameras, memories, video cards, displays, disk 406, network devices 420, and the like. The input/output ports 410 can include but are not limited to, serial ports, parallel ports, and USB ports.

The computer 400 can operate in a network environment and thus may be connected to network devices 420 via the I/O interfaces 418, and/or the I/O ports 410. Through the network devices 420, the computer 400 may interact with a network. Through the network, the computer 400 may be logically connected to remote computers. The networks with which the computer 400 may interact include, but are not limited to, a local area network (LAN), a wide area network (WAN), and other networks. The network devices 420 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 420 can connect to WAN technologies including, but not limited to, point to point links, circuit switching networks like integrated services digital networks (ISDN), packet switching networks, and digital subscriber lines (DSL).

### EXAMPLE 1

### Monk's Problems

The MONK's problems, as described in Thrun, S. B., et al., “The MONK's problems—a performance comparison of different learning algorithms”, Technical Report CS-CMU-91-197, CMU, 1991, which is incorporated herein by reference, have been used as a standard to compare many different learning algorithms. The task is to classify robots described by the following six different features:

| | |
|---|---|
| x₁: head_shape | ∈ round, square, octagon |
| x₂: body_shape | ∈ round, square, octagon |
| x₃: is_smiling | ∈ yes, no |
| x₄: holding | ∈ sword, balloon, flag |
| x₅: jacket_color | ∈ red, yellow, green, blue |
| x₆: has_tie | ∈ yes, no |

The class of a robot is given by a logical description. Whether a robot belongs to the class or not depends on whether it satisfies the description. There are totally 432 possible robots, but only a subset is given as the training examples and all examples are used for test. The learning task is to generalize over these training examples so as to derive a simple class description. Three problems are defined and their class descriptions are given as following:

MONK-1: head shape=body shape or jacket color=red (124 training examples)

MONK-2: exactly two of the six attributes have their first value (169 training examples)

MONK-3: (jacket color is green and holding a sword) or (jacketcolor is not blue and body shape is not octagon) (122 training examples with 5% class noise).

Feature x₁ has three discrete values and is transformed into three binary features by cross tabulation in order to train neural networks which require continuous-valued input features. The three tabulated features are denoted as x₁₋₁, x₁₋₂, and X₁₋₃. Similarly, feature x₂ is transformed into x₂₋₁, x₂₋₂, and x₂₋₃, feature x₄ is transformed into x₄₋₁, x₄₋₂, and x₄₋₃ and feature x₅ is transformed into x₅₋₁, x₅₋₂, x₅₋₃ and x₅₋₄. Altogether there are 15 binary input features and one binary output.

We return to the class definition of MONK's problems to check the relevancies of these 15 tabulated features to the problems. For the first problem, we can see that seven features, x₁₋₁, x₁₋₂, x₁₋₃, x₂₋₁, x₂₋₂, x₂₋₃ and x₅₋₁, are relevant to the problem. For the second problem, six features, x₁₋₁, x₂₋₁, x₃, x₄₋₁, x₅₋₁ and x₆, are relevant to the problem. For the third problem, four features, x₂₋₃, x₄₋₁, x₅₋₃ and X₅₋₄, are relevant to the problem.

The three feature weighting methods discussed above, FWMLP, FWRBF and FWSVM were applied to the MONK's problems. The results by these methods are given in Table 1. As can be seen from the table, high classification accuracies were obtained in most cases.

TABLE 1
Results of feature weighting methods for MONK's problems

| | MONK-1 | MONK-2 | MONK-3 |
|---|---|---|---|
| FWMLP | 100% | 100% | 97.2% |
| FWRBF | 100% | 96.8% | 100% |
| FWSVM | 100% | 100% | 96.8% |

As mentioned, one objective of the MONK's problems is to infer a simple class description for each problem. To achieve this, it is important to first identify which features are relevant to the class information. Therefore, it is interesting to examine feature weights learned by three feature weighting methods. The learned feature weights are presented in Table 2. For the first problem, both the FWRBF and FWSVM method assigned large weights to seven relevant features. The FWMLP assigned large weights to five relevant features. But, the tabulated features are not independent. For example, the sum of feature x₁₋₁, x₁₋₂ and x₁₋₃ is 1 and therefore we only need know two of them. The FWMLP method actually identified the minimal set of relevant and independent features. For the second problem, all three methods correctly assigned large weights to six relevant features. For the third problem, all three methods assigned large weights to feature x₂₋₃ and X₅₋₄. Only the FWRBF method assigned large weights to feature x₄₋₁ and x₅₋₃. This is not surprising because feature x₄₋₁ and x₅₋₃ contribute little to the class definition. Ignoring these two features causes only less than 3% classification error, which is smaller than the 5% class noise added to the training examples.

Once the relevant features have been identified, it is easier to discover the internal logical relationships in data. In this example, we can discover the class descriptions for the first two problems even manually. Part of the class description of the third problem may not be discovered.

TABLE 2
Feature weights learned for MONK's problems

| | MONK-1 | | | MONK-2 | | | MONK-3 | | |
|---|---|---|---|---|---|---|---|---|---|
| | FWMLP | FWRBF | FWSVM | FWMLP | FWRBF | FWSVM | FWMLP | FWRBF | FWSVM |
| x₁₋₁ | 0 | 0.11 | 0.12 | 0.16 | 0.17 | 0.15 | 0 | 0.02 | 0 |
| x₁₋₂ | 0.17 | 0.11 | 0.12 | 0 | 0 | 0 | 0 | 0.01 | 0 |
| x₁₋₃ | 0.29 | 0.17 | 0.12 | 0 | 0 | 0 | 0 | 0.04 | 0 |
| x₂₋₁ | 0.20 | 0.13 | 0.13 | 0.15 | 0.15 | 0.11 | 0 | 0.08 | 0 |
| x₂₋₂ | 0.18 | 0.12 | 0.12 | 0 | 0 | 0 | 0 | 0.01 | 0 |
| x₂₋₃ | 0 | 0.15 | 0.11 | 0 | 0 | 0 | 0.5 | 0.24 | 0.52 |
| x₃ | 0 | 0 | 0 | 0.18 | 0.18 | 0.20 | 0 | 0.02 | 0 |
| x₄₋₁ | 0 | 0 | 0 | 0.16 | 0.15 | 0.17 | 0 | 0.18 | 0 |
| x₄₋₂ | 0 | 0 | 0 | 0 | 0 | 0 | 0 | 0 | 0 |
| x₄₋₃ | 0 | 0 | 0 | 0 | 0 | 0 | 0 | 0 | 0 |
| x₅₋₁ | 0.16 | 0.20 | 0.27 | 0.16 | 0.21 | 0.21 | 0 | 0.01 | 0 |
| x₅₋₂ | 0 | 0 | 0 | 0 | 0 | 0 | 0 | 0 | 0 |
| x₅₋₃ | 0 | 0 | 0 | 0 | 0 | 0 | 0 | 0.14 | 0 |
| x₅₋₄ | 0 | 0 | 0 | 0 | 0 | 0 | 0.5 | 0.27 | 0.48 |
| x₆ | 0 | 0 | 0 | 0.17 | 0.14 | 0.16 | 0 | 0 | 0 |

### EXAMPLE 2

### Leukemia Gene Expression Data

Cancer classification has become an interesting area in bioinformatics study since Golub et al. presented their weighted voting approach to classify two types of leukemia cancers using gene expression data, as described in Goulub, T. et al., “Molecular classification of cancer: class discovery and class prediction by gene expression monitoring,” Science, vol. 286, pp. 531-537, 1999], which is incorporated herein by reference. The gene expression data have several special characteristics. First, the advances of DNA microarray techniques have made it possible to monitor simultaneously a large number of genes. As a result, the gene expression data usually consists of expression values of tens of thousands of genes. The most recent results have revealed that there are possibly 20,000 to 25,000 protein-coding genes in the human genome. Secondly, due to a variety of reasons, the number of available samples is very limited, which can range from only a few to a couple of hundreds. Thirdly, many genes are highly correlated and only a subset of genes relate to the cancers. These characteristics bring some challenges to the training of classification models. If all the genes are used to train neural networks, it is very easy to cause overfitting. Therefore feature selection or feature weighting may be used with neural networks in order to get a generalized classification model.

There are two purposes for the study of cancer classification using gene expression data. The first one is to learn a classification model for cancer diagnosis. Many different methods have been proposed and high classification accuracy has been achieved. For some gene expression datasets, we are able to classify cancer samples with high accuracy using a simple linear classifier with only a few genes. One plausible explanation is that the phenotype for cancers is so abundant that many genes may relate to the cancer and can be used in classification models. Therefore any classification model that uses enough related genes can achieve high classification accuracy.

A more important and challenging task is to identify cancer-related genes that can be used to design drugs for cancer treatment. The cell's behavior is determined by the off-and-on pattern of its genes. With a limited number of gene expression samples, it is possible that some genes can have unique and distinctive patterns across different cancer types. These genes highly relate to the cancers and can be easily identified. But they may not necessarily be the only genes that relate to the cancers. First, due to the knowledge limitation, there might be unknown subclasses for a given cancer class. For this reason, there exist some genes that have distinctive patterns among the subclasses and these genes should relate to the cancers. Secondly, when a cancer is developed due to malfunctioning or non-functioning of some genes, it is possible that the same cancer may be developed due to quite different sets of genes. These genes do not have distinctive patterns across different cancer types, but they relate to the cancer in a subtle and nonlinear way. For the above two reasons, there may exist some genes that do not have distinctive patterns across different cancer types, but are important and relate to the cancers. Through nonlinear classification models such as neural networks, all related genes, either with distinctive patterns or not, can be identified.

Gene expression data of many different types of cancers have been studied and some datasets are made publicly available from internet such as the Colon-cancer data, the Leukemia data and the Lymphoma data etc. In this example, iterative feature weighting methods are applied to the Leukemia data used in Golub et al. The task is to classify acute myeloblastic leukemias (AML) and acute lymphoblastic leukemias (ALL) based on the expression values of 7129 genes. There are 38 samples that can be used for training, with 27 ALL and 11 AML each. Another 34 independent samples are available for test, with 20 ALL and 14 AML each.

Exemplary feature weighting methods, FWMLP, FWRBF and FWSVM, were applied to the data set. For the FWMLP method, the 38 training samples were equally divided into two datasets, 19 samples used for training and the other 19 samples are used for validation. The MLP network was set up to have two hidden layers, 6 neurons in the first layer, and 3 neurons in the second layer. Feature elimination threshold was set as 0.05.

For the FWRBF method, the 38 training samples were randomly divided into two datasets, one for training and one for validation, and the procedure was repeated for 50 times. 50 RBF networks were trained and averaged to get a generalized model. The average model was then used to update gene weights via gradient descent.

For the FWSVM method, the 38 training samples were also randomly divided into two datasets, one for training and one for validation, and the procedure was repeated 50 times. 50 SVMs were trained and averaged to get a generalized SVM. The averaged SVM was then used to update gene weights. Feature elimination threshold was set as 0.1.

Table 3 gives the results on the 34 test samples. For the FWMLP method, 20 iterations were used to train the MLP networks and 2470 genes were selected with nonzero weights. Only one test sample was misclassified. For the FWRBF method, 30 iterations were used to train the RBF networks and 1275 genes were selected with nonzero weights. Again only one test sample was misclassified. For the FWSVM method, 12 iterations were used to train the SVMs and 704 genes were selected with nonzero weights. No test sample was misclassified.

TABLE 3
Results of feature weighting methods for Leukemia gene expression data

| | No. of | No. of | |
|---|---|---|---|
| Method | iterations | selected genes | Misclassifications |
| FWMLP | 20 | 2470 | 1 misclassified, sample id 66 |
| FWRBF | 30 | 1275 | 1 misclassified, sample id 66 |
| FWSVM | 12 | 704 | none |

Table 4 lists the gene access numbers of the top 100 genes with largest feature weights learned by the three feature weighting methods.

TABLE 4
Top 100 genes ranked by feature weighting methods

| Method | Gene access number of top 100 genes |
|---|---|
| FWMLP | Y12670, D49950, M19507, X55668, M22960, M83652, M23197, M60298, |
| | X85116, U50136, M27891, X51420, Y00339, X95735, M16038, X14008, |
| | M84526, M24400, M71243, X62654, HG2855-HT2995, M32304, Z49205, |
| | X56411, X70297, M29610, X16546, L13278, X17042, L02867, M33195, |
| | X52056, D88422, M57710, 68891, X91504, M17754, U66580, AFFX- |
| | BioDn-3, M19045, D87076, U90544, U25128, HG4518-HT4921_r, S67247, |
| | X59350, U18543, X91257, X01060, M20902, M27783, U81001, |
| | U12471_cds1, X53595, X15414, M80254, X05409, M27749_r, X62320, |
| | M84371, D86975, U58091, HG2380-HT2476, U73960, X13839, M55150, |
| | U85767, M96326, HG4058-HT4328, M86406, M95678, U37518, L41349, |
| | M64936, M21005, L02648, X07820, D49817, L06797, Y07604, U66561, |
| | L08177, M83667, AF001620, U33822, X54326, D21851, S72043, M60828, |
| | M12125, AF005775, X06614, X06482, M19159, X15882, X64364, D87742, |
| | X64072, U91903, D87116 |
| FWRBF | M23197, U50136, X95735, U37055, U82759, Y12670, D49950, M55150, |
| | M84526, M96326, M22960, M16038, M83652, X70297, M98399, M19507, |
| | M27891, Y07604, M80254, X58431_rna2, M37435, D43682, M63138, |
| | X16546, Y00339, M81933, X85116, Z32765, U40434, X17042, M62762, |
| | K03195, U59632, M71243, U46751, M68891, M75715, X52056, Y08612, |
| | M27783, M83667, X68688, X55668, L17131, S77893, X94232, L11669, |
| | L06797, L09209, M57710, D23673, X04085, X64594, M81695, L08246, |
| | L38608, M31303, M31211, M20203, HG627-HT5097, M92287, M31994, |
| | L00634, U67963, X64364, U20499, U46499, U05259, X15414, D26308, |
| | D87076, L08177, U61836, HG3725-HT3981, HG4321-HT4591, |
| | X66867_cds1, M26708, X14008, X13955, M58297, U51004, U90552, |
| | HG1612-HT1612, HG4126-HT4396, M54995, U70063, X64072, L42379, |
| | L05148, M19045, J04027, D50923, M95678, L47738, M21551, M63838, |
| | D86967, U22376_cds2, X74262, M12959 |
| FWSVM | Y12670, D49950, M23197, X95735, M19507, M81933, U82759, U50136, |
| | X85116, U63289, M37435, M24400, U22376_cds2, X70297, M61853, |
| | M55150, X81479, M83652, M26708, M16038, U43292, M84526, X63753, |
| | M80254, U37055, U92459, X51521, M27891, X17042, M96326, |
| | U12471_cds1, U43885, M77810, D21851, M68891, Y00339, L08246, |
| | M75715, U95626_rna3, M62762, U46751, X55668, L25286, M31158, |
| | S81439, X04085, HG2562-HT2658, M31303, X06948, M20902, AFFX- |
| | ThrX-5, M62982, X16901, HG1612-HT1612, M86406, Y07604, X68688, |
| | D87076, Z29481, J04621, U20816, X13839, X53595, M63138, L47738, |
| | M98399, L06797, Y10207, U10473, X56411, U51004, U27460, L41607, |
| | M95178, X14046, M13690, M22960, X74262, AFFX-DapX-5, D64108, |
| | L05148, X05409, U53468, U67963, M58297, X05323, M19309, U59877, |
| | U60666, D38524, M31994, M21551, U05259, M86873, X58431_rna2, |
| | HG4518-HT4921_r, L49229, M20642, M29610 |

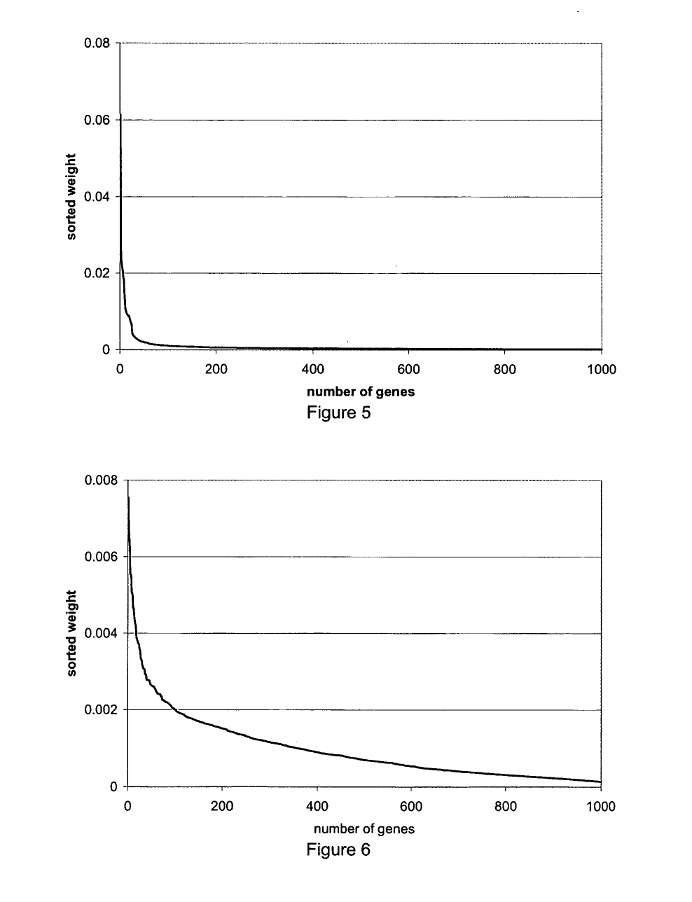

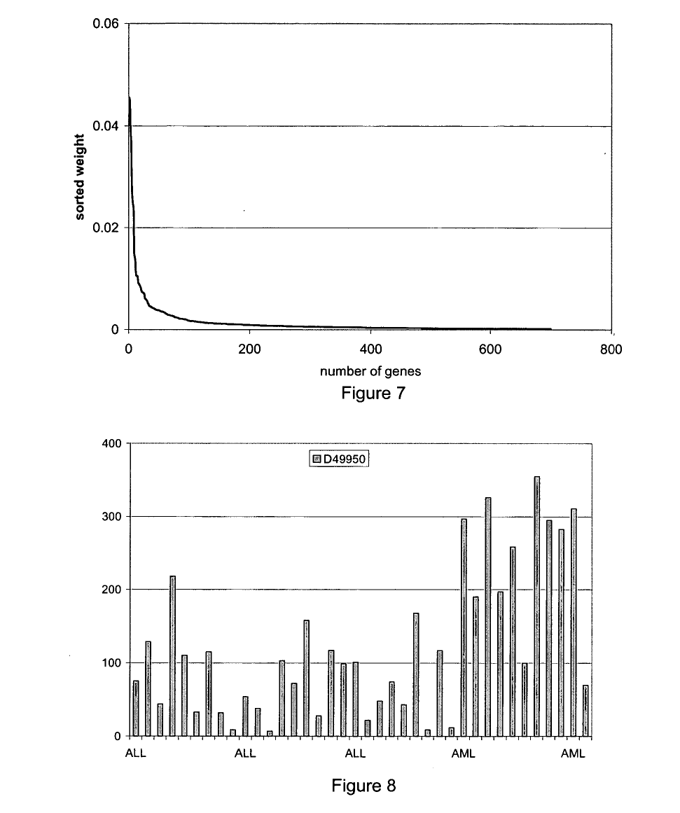

FIGS. 5, 6 and 7 illustrate plots of the gene weights learned by three feature weighting methods. FIG. 5 shows gene weights learned by FWMLP method. FIG. 6 shows gene weights learned by FWRBF method. FIG. 7 shows gene weights learned by FWSVM method. Gene weights were sorted and normalized so that the sum of all gene weights equals to 1. As can be seen from these figures, there are many genes selected by all three methods, but only a small number of genes have weights that are significantly larger than others.

Since the three feature weighting methods use different neural network architectures and have different learning processes, it may be interesting to compare and combine their results together. If a gene is weighted favorably by all three methods, it may be more likely that it is truly relevant to the cancers. Therefore gene weights learned by the three methods are summed up to rank genes. The 10 genes with largest summed weights are listed in Table 5 with their summed weights, gene access numbers and gene descriptions.

In Golub's paper, 50 genes were selected as the highly informative genes to distinguish ALL and AML. The choice of a gene is based on its signal-to-noise ratio (SNR). For a given gene, the means and standard deviations of its expression values in the two classes was computed as u₁, u₂, s₁ and s₅. Then its SNR equals to (u₁−u₂)/(s₁+s₂). Genes with large values of SNR were selected. Therefore, they have very distinctive patterns and are strongly correlated to the ALL-AML class distinction. From our results, 7 out of 10 genes are such kind of genes. For example, gene Leptin receptor, which shows high expression in AML, has been demonstrated to have antiapoptotic function in hematopoietic cells as described in Konopleva, M., et al., “Expression and Function of Leptin Receptor Isoforms in Myeloid Leukemia and Myelodysplastic Syndromes: Proliferative and Anti-Apoptotic Activities”, Blood, vol 93, pp. 1668-1676, 1999, which is incorporated herein by reference, and gene CD33 antigen, which encodes cell surface proteins, has been demonstrated to be useful in distinguishing lymphoid from myeloid lineage cells as described in Dinndorf, P. A., et al., “Expression of Myeloid Differentiation Antigens in Acute Nonlymphocytic Leukemia: Increased Concentration of CD33 Antigen Predicts Poor Outcome—a Report from the Childrens Cancer Study Group”, Med. Pediatr. Oncol., vol. 20, pp. 192-200, 1992, which is incorporated herein by reference. But it is also noticeable that there are also 3 genes highly ranked in our methods but not highly “informative” if defined by SNR. Especially the two genes, D49950 and M19507, rank second and fourth respectively. These genes may not be informative to distinguish ALL and AML individually, but they do play an important role in our neural network classifiers.

TABLE 5
Top 10 genes ranked by feature weighting methods

| | Gene | |
|---|---|---|
| Summed | Access | |
| weights | No. | Gene Description |
| 0.113 | Y12670 | LEPR Leptin receptor * |
| 0.077 | D49950 | Liver mRNA for interferon-gamma inducing |
| | | factor(IGIF) |
| 0.065 | M23197 | CD33 CD33 antigen (differentiation antigen) * |
| 0.056 | M19507 | MPO Myeloperoxidase |
| 0.053 | X95735 | Zyxin * |
| 0.043 | U50136 | Leukotriene C4 synthase (LTC4S) gene * |
| 0.034 | M83652 | PFC Properdin P factor, complement * |
| 0.034 | X85116 | Epb72 gene exon 1 * |
| 0.031 | U82759 | GB DEF = Homeodomain protein HoxA9 mRNA * |
| 0.030 | M81933 | CDC25A Cell division cycle 25A |

(* indicates informative genes selected by Golub et al.)

FIG. 8 plots the expression profile of gene D49950 in 38 training samples. As can be seen, though the average of gene expression values is higher in AML samples, gene D49950 is not so distinctive between ALL and AML samples.

The GenBank of National Center for Biotechnology Information (NCBI) provides the following summary on gene D49950 (IL 18): The protein encoded by this gene is a proinflammatory cytokine. This cytokine can induce the IFN-gamma production of T cells. The combination of this cytokine and IL12 has been shown to inhibit IL4 dependent IgE and IgG1 production, and enhance IgG2a production of B cells. IL-18 binding protein (IL18BP) can specifically interact with this cytokine, and thus negatively regulate its biological activity.

From GenBank, two related articles are listed that studied this gene's bioactivity acute in leukemia. One article showed this gene can express in all different leukemia types as described in Takubo, T., et al., “Analysis of IL-18 bioactivity and IL-18 mRNA in three patients with adult T-cell leukaemia, acute mixed lineage leukaemia, and acute lymphocytic leukaemia accompanied with high serum IL-18 levels”, Haematologia (Budap), vol. 31, no. 3, pp. 231-235, 2001, which is incorporated herein by reference. However, a more recent article stated that the gene might play a role in the clinical aggressiveness of AML, which is described in Zhang, B., et al., “IL-18 increases invasiveness of HL-60 myeloid leukemia cells: up-regulation of matrix metalloproteinases-9 (MMP-9) expression”, Leukemia Research, vol. 28, no. 1, pp. 91-95, 2004, which is incorporated herein by reference.

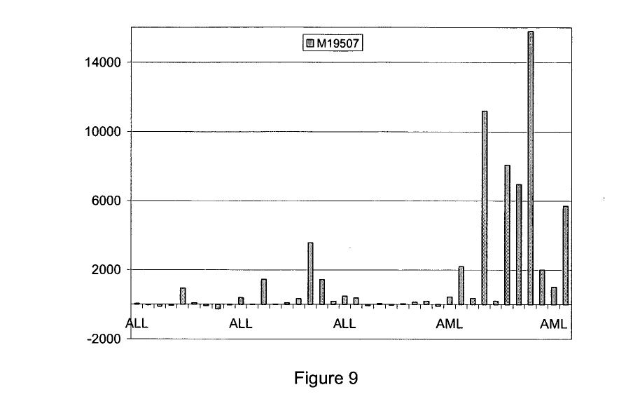

FIG. 9 plots the expression profile of gene M19507 in 38 training samples. As can be seen, the gene does not express in most samples, but it does highly express in some AML samples. Individually the gene may not be a good indicator to distinguish ALL and AML, but it can be used as an accurate indicator of AML if it has very high expression values.

For gene M19507, the GenBank of NCBI provides the following summary: Myeloperoxidase (MPO) is a heme protein synthesized during myeloid differentiation that constitutes the major component of neutrophil azurophilic granules. Produced as a single chain precursor, myeloperoxidase is subsequently cleaved into a light and heavy chain. The mature myeloperoxidase is a tetramer composed of 2 light chains and 2 heavy chains. This enzyme produces hypohalous acids central to the microbicidal activity of netrophils.

MPO is one of mostly important cytochemical studies in acute leukemia. Clinically the MPO stain has been used to distinguish between the immature cells in AML (cells stain positive) and those in ALL (cells stain negative). It has also been used together with deoxynucleotidyltransferase (TdT) to identify ALL. A combination of MPO positivity of less than 3% of the blasts and a strong positive expression of TdT (less than 40% of the blasts) is usually indicative of a diagnosis of ALL as described in Cortes, J. E., and H. Kantaijian, “Acute Lymphocytic Leukemia”, in Medical Oncology: A Comprehensive Review, 2nd Ed, ed. R. Pazdur, 1997, which is incorporated herein by reference. So this is an excellent “marker” gene for AML and ALL.

From the above analyses, we can see that although the two highly ranked genes, D49950 and M19507, are not very informative in visually discriminating AML and ALL, they are still of biological significance and may relate to acute leukemia by correlating to other genes and influencing the interactions between genes in the same biological pathway.

Applying the concepts disclosed here, results on the MONK's problems have shown that these methods are effective in identifying relevant features that have complex logical relationships in data. Results for the Leukemia gene expression data show that these methods can be used not only to improve the accuracy of pattern classification, but also to identify features that may have subtle nonlinear correlation to the task in question.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A computer-executable method for weighting features to distinguish feature relevancies in neural network computing, the computer-executable method comprising the steps of:
(a) initializing a feature weight for each feature in a neural network model;
(b) inputting data points in a neural network learning algorithm;
(c) training the neural network model with the neural network learning algorithm;
(d) evaluating the feature weights in the neural network model based on the neural network learning algorithm;
(e) updating the feature weights in the neural network model based on the evaluating step;
(f) scaling the data points in the neural network learning algorithm; and
(g) repeating steps (b) through (f) until a stopping criteria is reached.

2. The computer-executable method of claim 1, wherein the step of scaling the data points includes a step of multiplying each data point by a corresponding feature weight.

3. The computer-executable method of claim 1, wherein the step of scaling the data points includes the step of multiplying each data point by a square root of a corresponding feature weight.

4. The computer-executable method of claim 1, wherein the step of evaluating the feature weights includes a step of estimating the value of each feature weight based on a partial derivative of a feature evaluation function with respect to input features according to the equation:
$${σ}_{i} = \frac{1}{P} {\sum }_{p = 1}^{P} \vert \partial f ( {x}^{( p )} ) / \partial {x}_{i} \vert$$
wherein σᵢ is the i^{th} feature weight;
f(·) is the neural net model;
xᵢ is the i^{th} input feature.

5. The computer-executable method of claim 1, wherein the step of evaluating the feature weights includes a step of estimating the value of each feature weight based on a partial derivative of a feature evaluation function with respect to the feature weights.

6. The computer-executable method of claim 1, wherein the step of evaluating the feature weights includes a step of setting a feature weight equal to zero if it is below an elimination threshold.

7. The computer-executable method of claim 6, wherein the elimination threshold is relative to the other feature weights.

8. The computer-executable method of claim 6, wherein the elimination threshold is determined according to the equation:
$${max}_{{σ}_{thresh}} ( {\sum }_{{σ}_{i} < {σ}_{thresh}} {σ}_{i} \leq τ \sum {σ}_{i} )$$
wherein σᵢ is the i^{th} feature weight;
σₜₕᵣₑₛₕ is the elimination threshold; and
τ is a relative elimination threshold parameter.

9. The computer-executable method of claim 1, wherein the step of evaluating the feature weights includes a step of changing a feature weight in proportion to the partial derivative of a mean squared error of the neural network model, with respect to the feature weight.

10. The computer-executable method of claim 1, wherein the step of evaluating the feature weights includes a step of changing a feature weight according to the equation:
$${Δσ}_{i} = - η \frac{\partial MSE}{\partial {σ}_{i}}$$
wherein σᵢ is the i^{th} feature weight;
η is an updating rate; and
MSE is a mean squared error of the neural network, computed as:
$$MSE = \frac{1}{2 P} {\sum }_{p = 1}^{P} {( {t}^{( p )} - f ( {x}^{( p )} ) )}^{2}$$
wherein x^{(p)} is a training sample and t^{(p)} is a target value of a training sample.

11. The computer-executable method of claim 1, wherein the neural network learning algorithm is a monotonic neural network learning algorithm.

12. The computer-executable method of claim 1, wherein the neural network learning algorithm improves the neural network model over each iteration.

13. The computer-executable method of claim 1, wherein the neural network learning algorithm improves the evaluated feature weights by improving the neural network model over each iteration.

14. The computer-executable method of claim 1, wherein the neural network learning algorithm is a greedy algorithm.

15. The computer-executable method of claim 1, wherein the stopping criteria is selected from at least one of: reaching a predetermined maximum number of iterations; reaching a predetermined maximum number of tries for the neural network learning algorithm to learn an improved model; creating a neural network model that is below a predetermined quality threshold; and outputting feature weights having a relative change that is less than a predetermined threshold.

16. A computer-executable method for iteratively weighting features in a multilayer perceptron network, the computer-executable method comprising the steps of:
(a) initializing feature weights in a multilayer perceptron network;
(b) initializing a weight decay coefficient in a backpropagation algorithm;
(c) using the feature weights to scale training and validation datasets;
(d) initializing a multilayer perceptron network model;
(e) training the multilayer perceptron network model with the backpropagation algorithm;
(f) computing a mean squared error of the training and validation datasets;
(g) computing an R-squared value for the validation set;
(h) determining whether the mean squared error of the training and validation datasets is less than the mean squared error of any previous iterations, and based on the determination, updating the feature weights of the multilayer perceptron network model;
(i) reducing the weight decay coefficient by half; and
(j) repeating at least steps (d) through (i) until a stopping criteria is reached.

17. The computer-executable method of claim 16, wherein the stopping criteria is one of: the mean squared error of the training and validation datasets falling below a predetermined threshold; the mean squared error of the multilayer perceptron network model being greater than the mean squared error of a best previous multilayer perceptron network model for a predetermined number of consecutive iterations; and reaching a predetermined maximum number of iterations.

18. The computer-executable method of claim 16, wherein step (j) further includes a step of determining whether the R-squared value of the validation set is larger than a predetermined threshold, and based on the determination, repeating steps (c) through (j).

19. A computer-executable method for iteratively weighting features in a radial basis function network, the computer-executable method comprising the steps of:
(a) initializing feature weights in a radial basis function network;
(b) setting a weight decay coefficient to an initial value;
(c) scaling training samples with the feature weights;
(d) performing k-fold cross validation;
(e) training k radial basis function networks with an orthogonal least square algorithm and weight decay;
(f) averaging the k radial basis function networks;
(g) estimating training and validation mean squared error for the averaged k radial basis function networks;
(h) determining whether the mean squared error of the averaged k radial basis function network is less than the mean squared error of any previous iterations, and based on the determination, updating the feature weights of the averaged k radial basis function networks;
(i) reducing the weight decay coefficient by half; and
A) repeating steps (c) through (j) until a stopping criteria is reached.

20. The computer-executable method of claim 19, wherein the stopping criteria is selected from one of: the mean squared error of the averaged k radial basis function networks falling below a predetermined threshold; reaching a maximum number of iterations; and the mean squared error of the radial basis function network being greater than the mean squared error of a best previous radial basis function network for a predetermined number of consecutive iterations.

21. A machine learning system for weighting features of a neural network, the system comprising:
initializing logic configured to initialize a feature weight for each feature in a neural network model;
training logic configured to train the neural network model with a neural network learning algorithm;
evaluation logic configured to evaluate the feature weights based on the neural network model and update the feature weights based on the evaluation; and
scaling logic configured to scale data for the neural network learning algorithm.

22. A computer-readable medium storing processor executable instructions operable to perform a method, the method comprising the steps of:
(a) initializing a feature weight for each feature in a neural network model;
(b) inputting data into a neural network learning algorithm;
(c) training the neural network model with the neural network learning algorithm;
(d) evaluating the feature weights based on the neural network model;
(e) updating the feature weights in the neural network model based on the evaluating step;
(f) scaling the data; and
(g) repeating steps (b) through (e) until a stopping criteria is reached.
